(19) United States
(12) Patent Application Publication
(10) Pub. No.: US 2007/0176901 A1
(43) Pub. Date: Aug. 2, 2007

(54) Computer Mouse Palm Deck

(76) Inventor: Roland Fujiyama, Hilo, HI (US)

Correspondence Address: ROLAND FUJIYAMA, 107 KEKELA ST., HILO, HI, 96720, US

(21) Appl. No.: 11/626,609

(22) Filed: Jan. 24, 2007

Related U.S. Application Data
(60) Provisional application No. 60/766,565, filed on Jan. 27, 2006.

(51) Int. Cl. G09G 5/08

(52) U.S. Cl. 345/163

(57) ABSTRACT

The invention is a device used in conjunction with a computer mouse and provides a flat platform for the entire palm area of the hand and thumb to rest upon and allows the remaining fingers to drape over its forward edge to engage any buttons or wheel. It utilizes a centrally located hole as a means to maintain its position upon a mouse and adhesives or mechanical fasteners or adhesive-backed hook and loop fasteners/tape, to provide permanence of the device to the mouse. The locating hole enables a variety of positions/angles for the device on a mouse to suit the comfort of the user without modifications to the device or mouse.

### BACKGROUND OF THE INVENTION

1. Field of the Invention

This invention is used in conjunction, with a computer mouse. It is a semi-rigid, flat platform that is adhered or fastened, to the top rear surface of a computer mouse. Its purpose is to provide an alternate position and support, for the hand, palm, thumb, and fingers, while using a variety of configurations of mice, from various manufacturers. The use of this device allows multiple locations and angles of attachment, to adapt to a user's comfort preference. It uses a centrally located hole to position and stabilize and offer resistance for maintaining said, position.

2. Description of Prior Art

The redesigning of, or by the use of attachments, to a computer mouse external shape, to alleviate physical discomfort, while operating said device, were discovered and disclosed, in the following United States patents.

U.S. Pat. No. 6,431,504 to Ignagni, is a device that provides a contoured top surface and a formed lower surface to aid in positioning and support, while being attached with an adhesive to a computer mouse, and its following description of its prior art is;

Four U.S. Pat. No. 6,157,370 to Kravtin, et al., U.S. Pat. No. 5,865,404 to Hesley, U.S. Pat. No. 5,913,497 to Myers and U.S. Pat. No. 5,762,302, also to Myers, are devices providing palm support to a computer mouse, attaching either directly to the rear of the computer mouse or by way of a tether to the rear of a computer mouse, these patents having a roller mechanism on the undersides to roll with the computer mouse, in a sort of trailer fashion. In U.S. Pat. No. D 419,540 to Salzman, a wrist and arm support are disclosed.

Items attaching to the upper surface of a computer mouse include U.S. Pat. No. 5,581,277 to Tajiri and U.S. Pat. No. 5,949,406 to Kress. The Tajiri patent is a ball configuration, mounted to the top of the computer mouse to curve the hand while using the computer mouse, while the Kress patent is a “crown” cradling three fingers of the hand which are the three operational fingers of the hand on a computer mouse. Neither of these provides a resting surface for the entire hand of the user.

Detachable and adjustable tabs attaching to the sides of a computer mouse are disclosed in U.S. Pat. No. 5,990,870 to Chen, et al. which provide several embodiments for allowing resting points for the thumb and pinky finger of the users hand during use of the computer mouse.

These prior arts address the comfort enhancements to a computer mouse, however, their mating surfaces, limit the adaptability and simplicity to which they can be applied securely, to the multitude of mice available.

### II. SUMMARY OF THE INVENTION

The primary objective of the invention is to provide a flat surface for the hand, with the entire palm area and thumb supported on the flat surface and the 4 remaining fingers allowed to drape over the forward edge, to engage buttons or a roller wheel, of an existing computer mouse of various manufacturers.

The use of a hole in the central position of the flat device is used as the means, to provide resistance, to sustain the position of the device. This hole makes the device simple to reproduce, because it allows the use on any flat material that can withstand the pressure of the hand upon the device and mouse combination. This is a key feature, of this invention, because it enables this invention to adapt to a wide variety of mouse physical shapes and features.

The use of double-sided adhesive sponge/foam tape or mechanical fasteners, such as, metal screws, or hook and loop adhesive-backed fasteners/tape (also known as Velcro) is used, to provide permanence to the adaptation of the device to a computer mouse. This also allows simple, easily applied techniques to adapt this device to a mouse, provided by various manufacturers

The size of the hole is determined, to allow a portion of the top rear section, of a computer mouse to protrude into the hole of the invention. This protrusion of the mouse offers, the physical resistance, necessary, for the invention to remain, in its desired position, chosen by the user, of the mouse and invention combination.

The shape of the hole can vary, from a circle, to a circle with a flat section, along its forward perimeter which, simulates the letter-D-. These holes shapes adapt to the basic cross sections of a computer mouse, which is either curved top or flat top, on its left to right, side to side axis.

The hole used to locate the device on a mouse can be visible or covered, when viewing the device from its top view.

Once a position has been chosen, for the location and angle of the invention, on a computer mouse, the use of double-sided adhesive sponge/foam tape or the alternate means of attachment, is used to adhere the invention to the mouse. Two lengths of adhesive tape are used to stabilize the positioning. The adhesive tape is positioned on the computer mouse in relation to the forward and rearward edge sections, of the hole. This enables a firmer anchoring of the adhesive tape. The desired placement of the adhesive tape on the mouse is to have the forward and rear edges of the hole bisect the adhesive tape along the length of the tape, as is practical. The length of each piece of adhesive tape, should be, no longer then the diameter of the hole.

An alternate means of attachment may use metal fasteners, such as screws, or adhesive-backed hook and loop fasteners/tape (also known as Velcro), to conjoin the device to a computer mouse in the same placement as used with the double-sided adhesive sponge/foam tapes.

### III. DESCRIPTION OF THE DRAWINGS

The following drawings are submitted with this utility patent application.

FIG. 1 is a top view of the invention attached to a computer mouse.

FIG. 2 is a left-side view of the invention attached to a computer mouse.

FIG. 3 is a top view of the invention, showing a circular locating hole, centrally located on the device.

FIG. 4 is a top view of the invention, showing a circular locating hole, with a flat section along the forward perimeter of the hole and centrally located on the device with the alternate metal fastener locations shown.

FIG. 5 is a top view of the invention with a portion of its top surface and the locating hole covered by a self-adhesive decal/sticker.

FIG. 6 is a top view of the invention with a portion of its top surface and the locating hole covered by a self-adhesive decal/sticker.

FIG. 7 is a top view of the invention on a mouse with its entire top surface and the locating hole covered with an additional layer of source material.

FIG. 8 is a left side view of the invention on a mouse with an additional layer of source material on its top surface.

FIG. 9 is a top view of a computer mouse with a dashed line used to represent a cross-section station as depicted in FIGS. 11 and 12.

FIG. 10 is a side view of a computer mouse with a dashed-line used to represent a cross-section station as depicted in FIGS. 11 and 12.

FIG. 11 is a cross-section view of a computer mouse with a flat top.

FIG. 12 is a cross-section view of a computer mouse with a rounded top.

FIG. 13 is the front view of the invention attached to a computer mouse with a flat top.

FIG. 14 is the front view of the invention attached to a computer mouse with a round top.

FIG. 15 is the top view of the invention with a hidden view of a locating hole within a ring of source material upon the lower surface of the device on a computer mouse.

FIG. 16 is the side view of the invention with a locating hole within a ring of the source material upon the lower surface of the device attached to a computer mouse.

### IV. DESCRIPTION OF THE PREFERRED EMBODIMENT

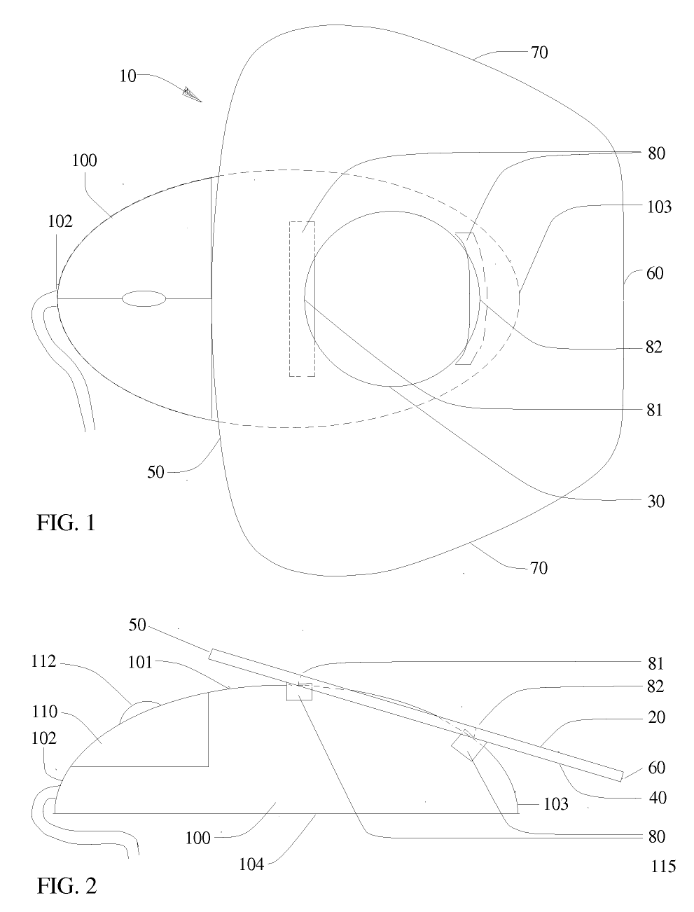

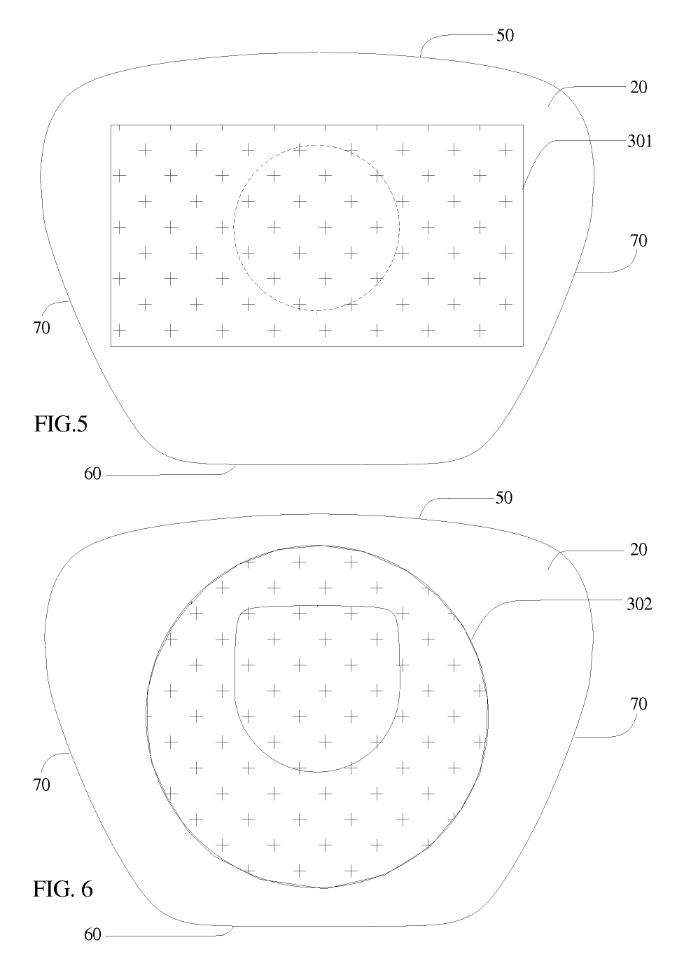

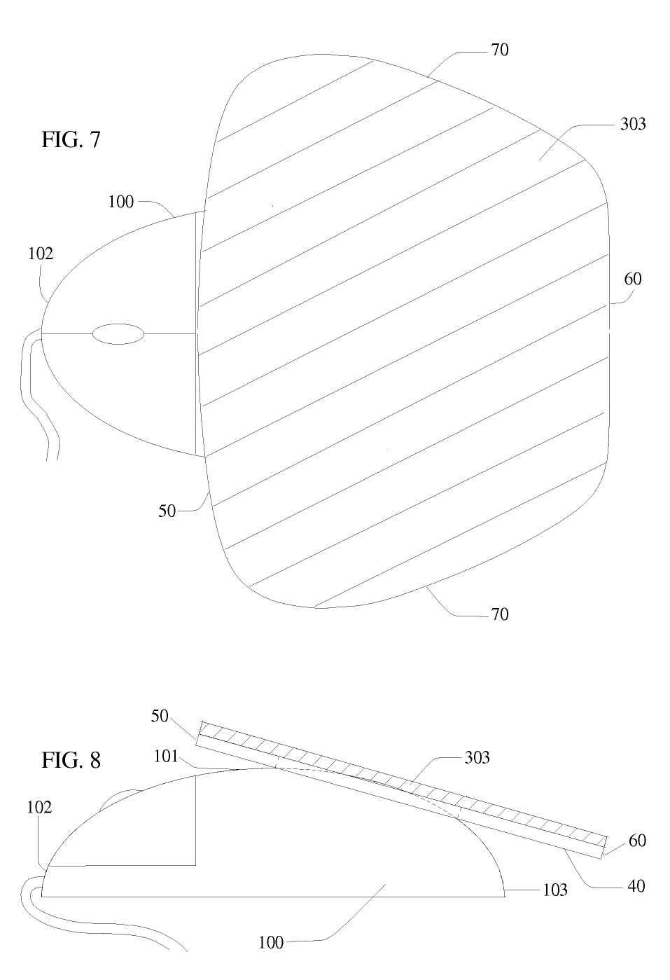

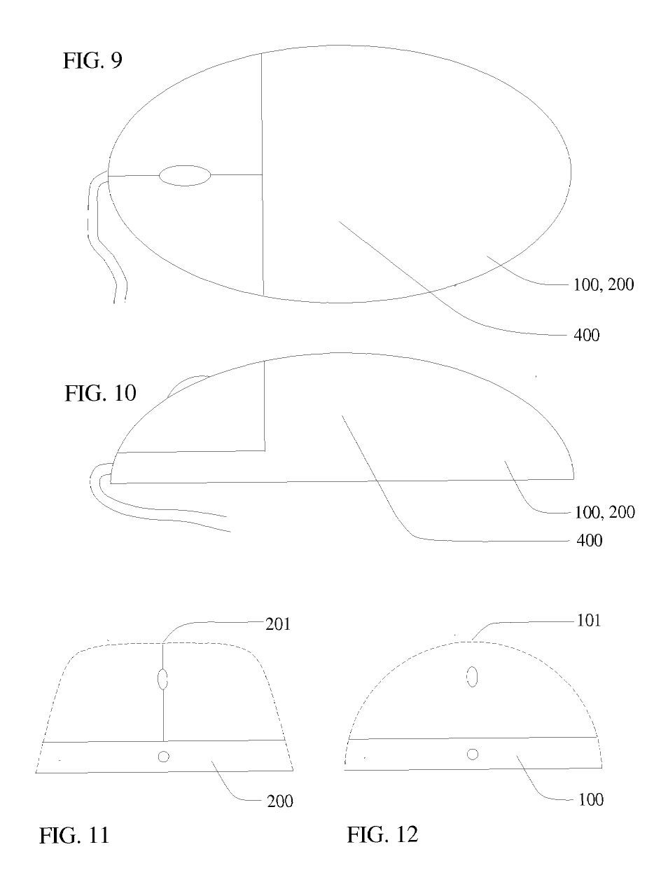

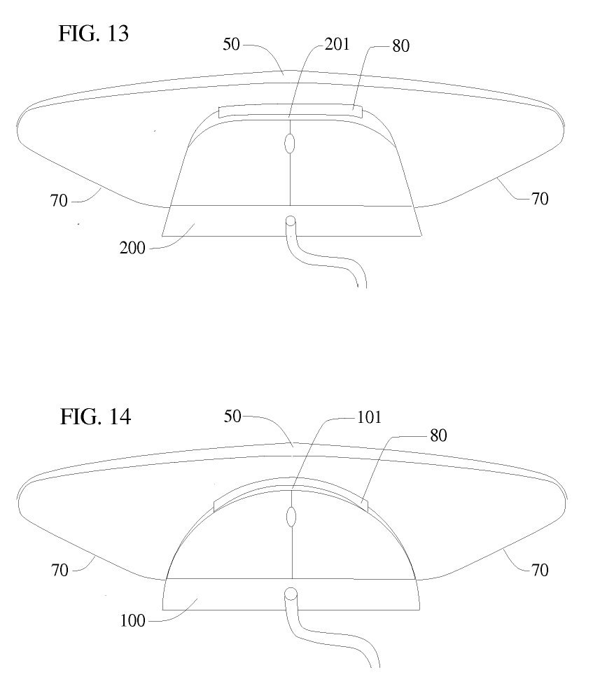

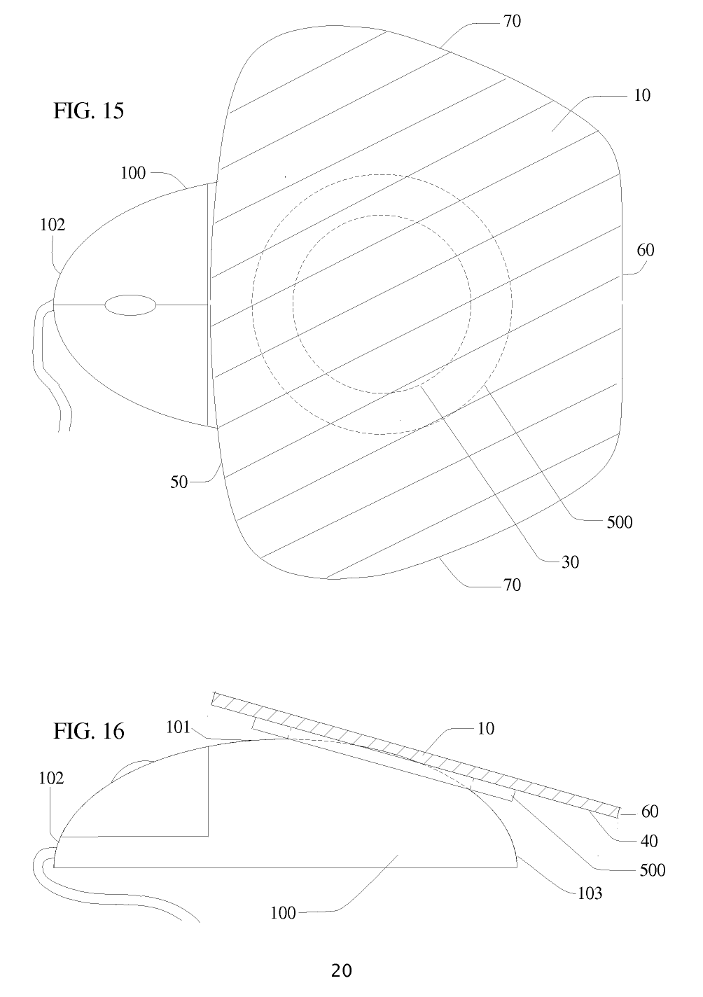

The invention, as shown in FIGS. 1-16 of the drawings, is a device 10 conjoined to the 101 or 201 upper surfaces of computer mouse 100 or 200, the device having a upper surface 20, a lower surface 40, a forward edge 50, a rear edge 60, two symmetrical side edges 70, a centrally located hole with shapes of 30 or 31, which also have forward edges 81 or 83 and rear edge 82 of said centrally located hole, and uses double-sided sponge/foam adhesive tape 80, or adhesive backed hook and loop fasteners/tape 80 or mechanical fasteners, such as metal screws at location 90, to provide a means of attachment to the upper surface 101 or 201 of computer mouse 100 or 200.

The upper surface 20 as shown in FIGS. 5, 6, 7 and 8, of the drawings, will utilize self-adhesive stickers 301, 302 or additional source material 303 to cover the centrally located holes 30 or 31, for cosmetic purposes or as a means to provide additional support for the device 10.

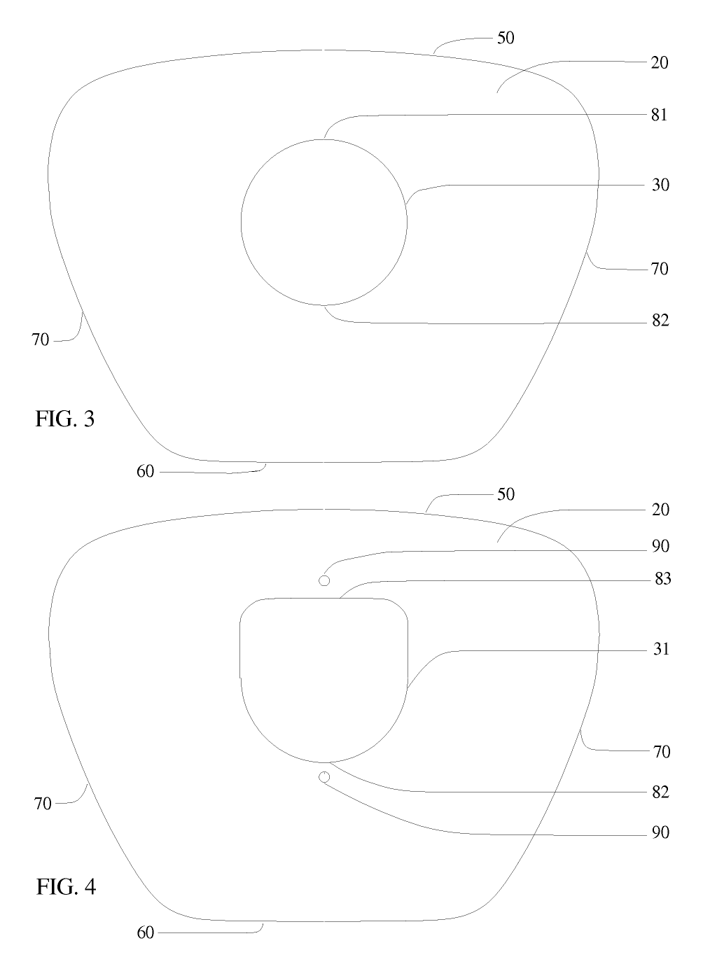

The centrally located holes 30 and 31 are utilized to locate and offer resistance on a computer mouse 100 or 200. The circular shaped hole 30 conforms to the rounded top 101 of computer mouse 100 by the cross-section line 400 as represented in FIG. 12 and the -D-shaped hole 31 which is circular but with a flat section along its forward perimeter, conforms to the flat top 201 of computer mouse 200 by the cross-section line 400 as represented in FIG. 11, and shown in FIGS. 3, 4, 9, 10, 13 and 14.

The forward edges 81 and 83 and rear edge 82 of the centrally located holes 30 and 31 are the positions where the double-sided adhesive sponge/foam tape 80 or adhesive-backed hook and loop fasteners/tape 80 are positioned on the lower surface 40 of the device 10 or the ring of source material 500.

The use of metal fasteners, such as screws, can be used through the holes 90 as an alternate means of attachment of the device 10 to the upper surface 101 or 201 of a computer mouse 100 or 200 as shown in FIG. 4.

The forward edge 50 of the device is set back from the front end 102 of a computer mouse 100, to allow the fingers of the hand to drape over the forward edge 50 of the device 10, to engage click buttons 110 or wheel 112 of the computer mouse 100, as shown in FIGS. 1 and 2, and has a curvature along its length that simulates the forward section of the palm area of the hand.

The rear edge 60 of the device 10 extends past the rear end 103 of the computer mouse 100, but remains above the bottom surface 104 of the computer mouse 100, so it doesn't interfere with normal mouse functions but enables a flat coverage area and support of the palm and thumb area of the hand, as shown in FIGS. 1 and 2.

The side edges 70 are symmetrical and taper inward from the wider forward section to the narrower rear section of the device 10 which matches the layout of the palm and thumb area of the hand and allows an ambidextrous use of the device as shown in FIGS. 1 and 2.

The ring of source material 500 with a locating hole 30 through it, upon the lower surface 40 of the device 10, is an alternate adaptation of the locating hole 30 to the device 10.

While the invention has been particularly shown and describes with reference to a preferred embodiment thereof, it will be understood by those skilled in the art that changes in form and detail may be made therein without departing from the spirit and scope of the invention.

What is claimed is:

1. A device used in conjunction with a computer mouse to enable a mouse user an alternate position and support for the hand, while operating a computer mouse, comprising:
A. a semi-rigid, flat platform that allows the entire palm and thumb, to rest upon the device, and the remaining fingers allowed to drape over the forward edge, to operate any buttons or wheel, while attached to a computer mouse,
B. a centrally located hole within or upon the flat platform to locate the device upon a computer mouse, which also offers a physical resistance when the mouse protrudes through the hole of the device to maintain the chosen position of the device,
C. a centrally located hole who's shapes are a circle or circle with a flat section along its forward perimeter, which simulates the letter -D- with the flat section being the forward edge of the hole,
D. a locating hole with edges remaining square to offer maximum resistance when applied to the adhesive surface,
E. a forward edge positioned approximately a quarter to a third way back from the forward end of a computer mouse, to allow the fingers access to buttons or wheels on a computer mouse with a curvature along its line, emulating the curve of the forward palm area line of the hand,
F. two symmetrical side edges, tapering inward from wider forward section to narrower rear section, emulating the shape of a human palm,
G. a rear edge that overhangs and extends past the rear edge of a computer mouse and remains suspended from the work station, to avoid contact with the mouse pad area and not interfere with normal mouse functions,
H. double-sided foam adhesive tapes or mechanical fasteners, such as screws, or adhesive-backed hook and loop fasteners/tape, to conjoin the device and a computer mouse, along the forward and rear edges of the hole used to locate the device to the mouse.

2. The invention as disclosed in claim 1, wherein the device allows for a multitude of positions/angles upon a computer mouse to be utilized to accommodate various computer work station layouts, thereby allowing the user to settle on a position/angle of comfort for the device that is most suited to the user's situation.

3. The invention as disclosed in claim 1, wherein the device uses a adhesive-backed sticker/decal or another layer of flat source material to cover the locating hole and a portion or whole of the top surface for cosmetic and/or structural purpose.
